(19) United States
(12) Patent Application Publication
(10) Pub. No.: US 2021/0357524 A1
(43) Pub. Date: Nov. 18, 2021

(54) SOFTWARE PRIVACY FILTER OVERLAY

(71) Applicant: International Business Machines Corporation, Armonk, NY (US)

(72) Inventors: Shunguo Yan, Austin, TX (US); Steven D. Clay, Taylor, TX (US); Michal Broz, Cedar Park, TX (US)

(21) Appl. No.: 15/930,502

(22) Filed: May 13, 2020

(51) Int. Cl. G06F 21/62; G06F 11/32; G06F 9/451

(52) U.S. Cl. CPC G06F 21/6245; G06F 9/451; G06F 11/327

(57) ABSTRACT

Input data for a computing device is received from one or more input devices. Whether there is visual hacking of the computing device is determined based on the input data. A user interface of the computing device is modified in response to determining there is visual hacking of the computing device.

### BACKGROUND

The present invention relates generally to the field of privacy screen overlays on computing devices, and more particularly to a privacy screen overlay with an automated risk detection and alternative screen reader invocation to continue the task.

A computer display is an output device that displays information in graphical images. Generally, a computer display comprises the display device, circuitry, casing, and a power supply. In computing, a computer display may be a standalone device (e.g., a computer desktop scenario) or integrated with the computer itself (e.g., a laptop scenario). The display device may be a thin film transistor liquid crystal display (TFT-LCD) with LED backing, cold-cathode fluorescent lamp (CCFL) backlighting, cathode ray tube (CRT), etc.

A privacy filter for a computer display may be implemented as a form of software on the user interface of the computer display. Privacy filters can restrict viewing to some or all of the user interface of the computer display.

### SUMMARY

Embodiments of the present invention include a computer-implemented method, computer program product, and system for providing a software based privacy filter. In an embodiment, input data for a computing device is received from one or more input devices. Whether there is visual hacking of the computing device is determined based on the input data. A user interface of the computing device is modified in response to determining there is visual hacking of the computing device.

### BRIEF DESCRIPTION OF THE DRAWINGS

FIG. 1 is a functional block diagram of a network computing environment, generally designated 100, suitable for operation of privacy program 112, in accordance with at least one embodiment of the invention.

FIG. 2 is a flow chart diagram depicting operational steps for privacy program 112, in accordance with at least one embodiment of the invention.

FIG. 3 is a block diagram depicting components of a computer, generally designated 300, suitable for executing privacy program 112, in accordance with at least one embodiment of the invention.

### DETAILED DESCRIPTION

Visual hacking is a cybersecurity threat that refers to individuals looking at the display of a computing device and attempting to steal on-screen information without the user of the computing device even noticing. This visual hacking may take between a few seconds and a few minutes as a person walks by to glance at a display of a computing device and take sensitive information which may be used later.

Embodiments of the present invention provide for determining if visual hacking occurs. Embodiments of the present invention provide for a software privacy filter overlay to hinder visual hacking if it is determined visual hacking is occurring. Embodiments of the present invention provide for audio output of data at least partially by the software privacy filter overlay so the user can still utilize the data found on the display.

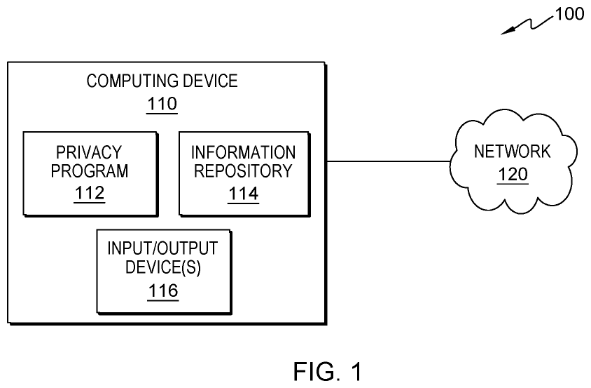

Referring now to various embodiments of the invention in more detail, FIG. 1 is a functional block diagram of a network computing environment, generally designated 100, suitable for operation of privacy program 112 in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims.

Network computing environment 100 includes computing device 110 interconnected over network 120. In embodiments of the present invention, network 120 can be a telecommunications network, a local area network (LAN), a wide area network (WAN), such as the Internet, or a combination of the three, and can include wired, wireless, or fiber optic connections. Network 120 may include one or more wired and/or wireless networks that are capable of receiving and transmitting data, voice, and/or video signals, including multimedia signals that include voice, data, and video formation. In general, network 120 may be any combination of connections and protocols that will support communications between computing device 110 and other computing devices (not shown) within network computing environment 100.

Computing device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, computing device 110 represents any programmable electronic devices or combination of programmable electronic devices capable of executing machine readable program instructions and communicating with other computing devices (not shown) within computing environment 100 via a network, such as network 120.

In various embodiments of the invention, computing device 110 may be a computing device that can be a standalone device, a management server, a web server, a media server, a mobile computing device, or any other programmable electronic device or computing system capable of receiving, sending, and processing data. In other embodiments, computing device 110 represents a server computing system utilizing multiple computers as a server system, such as in a cloud computing environment. In an embodiment, computing device 110 represents a computing system utilizing clustered computers and components (e.g. database server computers, application server computers, web servers, and media servers) that act as a single pool of seamless resources when accessed within network computing environment 100.

In various embodiments of the invention, computing device 110 includes privacy program 112, information repository 114, and input/output device(s) 116.

In an embodiment, computing device 110 includes a user interface (not shown). A user interface is a program that provides an interface between a user and an application. A user interface refers to the information (such as graphic, text, and sound) a program presents to a user and the control sequences the user employs to control the program. There are many types of user interfaces. In one embodiment, a user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, computing device 110 includes privacy program 112. Embodiments of the present invention provide for a privacy program 112 that provides a software privacy filter overlay. In embodiments of the present invention, privacy program 112 receives input data. In embodiments of the present invention, privacy program 112 determines visual hacking. In embodiments of the present invention, privacy program 112 modifies the overlay on the display of computing device 110. In embodiments of the present invention, privacy program 112 determines whether to use audio. In embodiments of the present invention, privacy program 112 determines the audio output. In embodiments of the present invention, privacy program 112 provides the audio.

In an embodiment, computing device 110 includes information repository 114. In an embodiment, information repository 114 may be managed by privacy program 112. In an alternative embodiment, information repository 114 may be managed by the operating system of computing device 110, another program (not shown), alone, or together with, privacy program 112. Information repository 114 is a data repository that can store, gather, and/or analyze information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided information repository 114 is accessible by computing device 110. Information repository 114 may include, but is not limited to, user preferences, thresholds, primary user facial profile, etc.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

In an embodiment, computing device 110 includes input/output device(s) 116. In an embodiment, input/output devices(s) 116 may include, but is not limited to, a camera, sensor, microphone, headset, or the like. In an embodiment, the sensors may include, but is not limited to, any sensor that can detect motion such as motion sensors, camera sensors, laser sensors, radar sensors, lidar sensors, distance sensor, angle sensor, etc. In an embodiment, a single input/output device 116 may include one or more of the above-referenced sensor. In an embodiment, input/output device(s) 116 may be integrated with computing device 110. In an alternative embodiment, not shown, input/out device(s) 116 may separate from computing device 110 but able to communicate with computing device 110 via network 120.

As referred to herein, all data retrieved, collected, and used, is used in an opt in manner, i.e., the data provider has given permission for the data to be used. For example, the received data from the input/output device(s) 116 that is used by privacy program 112 to determine potential privacy issues. As another example, the received data from what is being display on the user interface of computing device 110 is given permission to be used by privacy program 112.

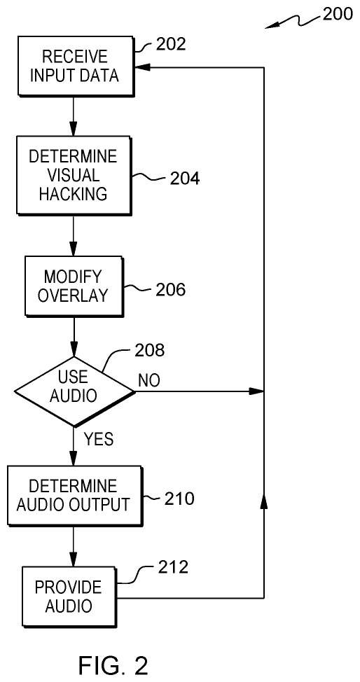

FIG. 2 is a flow chart diagram of workflow 200 depicting operational steps for privacy program 112 in accordance with at least one embodiment of the invention. In an alternative embodiment, the steps of workflow 200 may be performed by any other program while working with privacy program 112. It should be appreciated that embodiments of the present invention provide at least for providing a software based privacy filter on a user interface of computing device 110. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 200 upon a user wanting privacy program 112 to provide a software based privacy filter on a user interface of computing device 110.

Privacy program 112 receives input data (step 202). At step 202, privacy program 112 receives input data from one or more input/output device(s) 116. In an embodiment, privacy program 112 may receive input data that may include, but is not limited to a single image, multiple images or a video stream of an input/output device(s) 116. In an alternative embodiment, privacy program 112 may receive input data from an input/output device(s) 116 that determines motion has been activated, in other words there is motion. In yet another alternative embodiment, privacy program 112 may receive input data from an input/output device(s) 116 that indicates a new user is viewing the input/output device(s) 116 or is looking towards and/or at the input/output device(s). In example, the input data may be data from a webcam integrated into a computing device and the data includes a video stream that includes the primary user that is working at the computing device and another passerby, background user, that is looking at the screen.

At step 202, privacy program 112 may also receive input data from the user, user interface of computing device 110, and/or operating system of computing device 110 indicate which program and/or applications are viewable on the display. Additionally, privacy program 112 will also receive input data from the user or preferences saved in information repository 114 about levels of importance for applications and/or programs that can be viewed on computing device 110 and privacy thresholds that will determine what should and should not receive a software privacy filter using privacy program 112. In an embodiment, privacy program 112 may also receive input data about a facial profile of the primary user in order for privacy program 112 to determine who is the user of computing device 110 and therefore the one that is allowed to view the user interface of computing device 110.

Privacy program 112 determines visual hacking (step 204). At step 204, privacy program 112 uses the input data received in step 202 to determine if there is visual hacking of computing device 110. In an embodiment, privacy program 112 may determine visual hacking if any other user, besides the user of computing device 110, is looking in the direction of computing device 110. In other words, privacy program 112, using the input data received in step 202, determines whether any users are looking at computing device 110 by analyzing the input data received, for example an image. Privacy program 112 determines if a background user, besides the primary user that is using computing device 110, has their eyes looking in the direction of computing device 110. In an embodiment, privacy program 112 uses eye gazing analysis, known in the art, to determine the direction the background user is looking, and the area that the user is looking relative to the computing device 110. In an embodiment, privacy program 112 uses the facial profile of the primary user to determine if a background user that does not fit the facial profile of the primary user is looking at the computing device 110. In an embodiment, privacy program 112 may use the number of people and their distance and angle relative to the computer.

In an embodiment, privacy program 112 determines the eye gaze of the background user and then scores the eye gaze. In an embodiment, the score is relative to the amount of computing device 110 the background user is looking at. For example, if the input data received in step 202 determines that a background user is positioned directly in front of computing device 110 and the background user has an eye gaze centered directly at the middle of computing device 110 then privacy program 112 gives the background user a score of 0.9 (on a range of 0-1 and 1 indicates looking at computing device 110 and 0 indicates not looking at computing device 110). In another example, if the input data received in step 202 determiners that a background user is positioned to the side of computing device and the background user has an eye gaze centered at the side of computing device, then privacy program 112 gives the background user a score of 0.3. In these examples, privacy program 112 determines the threshold for determining visual hacking found in information repository 114 and compares the score to the threshold. Continuing the example, privacy program 112 determines the threshold to be 0.5, and therefore privacy program 112 determines the background user score in the first case to be higher than the threshold and therefore there is visual hacking, but determines the background user score in the second case to be lower than the threshold and therefore there is no visual hacking. In another embodiment, the angle the background user is viewing computing device 110 may be used to determine a score for the background user. For example, if the user is directly behind and therefore a viewing angle of approximately 90 degrees then this may be a score of 0.9. In an alternative example, is the user is to the side and therefore a viewing angle of approximately 45 degrees then this may be a score of 0.5. In this embodiment, the score is compared to a threshold to determine if visual hacking is occurring.

In an embodiment, privacy program 112 may score the eye gaze based on the amount of time a background user is looking at the screen. In other words, privacy program 112 may use a video input data to determine that a background user is staring at the screen for a duration of time. For example, if the background user stares at the screen for 0.5 seconds then the background user may be given a score of 0.1. In an alternative example, if the background user stares at the screen for 4 seconds then the background user may be given a score of 0.3. In yet another alternative example, if the background user stares at the screen for 7 seconds then the background user may be given a score of 0.7.

In another embodiment, privacy program 112 may score the eye gaze based on the distance, number and duration of other people from a range of viewable angles of computing device 110. For example, if three background users within three meters distance from 120 degree angle of the computer for three minutes, then the background users may be given a score of 0.8.

In an embodiment, privacy program 112 may provide input data received in step 202 and/or the determined background user score to the primary user of computing device 110 via the user interface of computing device 110. In this embodiment, privacy program 112 determines visual hacking based on a response from the primary user. In other words, primary user indicates to privacy program 112 that visual hacking is occurring based on an input from the primary user in the response to the data received in step 202 and/or the determined background user score provided to the primary user.

Privacy program 112 modifies overlay (step 206). At step 206, privacy program 112, based on the determine visual hacking in step 204, determines to modify the software privacy filter overlay. In other words, privacy program 112, modifies the user interface of computing device 110 with a software privacy filter overlay in response to the visual hacking. In an embodiment, a software privacy filter overlay may be a shading that provides a semi-transparent overlay of the user interface below the software privacy filter. In this embodiment, the overlay may include opacity in the range of 0-100% and more specifically opacity in the range of 20-70%. In an embodiment, a software privacy filter overlay may be a set of horizontal lines that are spaced. The overlay filter allows the active programs and/or applications, and their structures (paragraph, layout, section etc.) being viewed in order to allow the user to continue working on the apps/windows/content using alternative means (such as a screen reader. In this embodiment, the overlay may change based on the opacity and spacing of the lines based on the active program and/or applications. In other words, the opacity and distance of the shading lines are based on the active program and/or applications to hide the content but not the structure, and structure can be viewed and understood on the display of the computing device 110.

In an embodiment, privacy program 112 may determine, based on user preferences in information repository 114, that privacy program 112 should apply a software privacy filter overlay to the entire display of computing device 110. In an alternative embodiment, privacy program 112 may determine, based on user preferences in information repository 114, that specific designated programs and applications that are displayed on the display of computing device 110 should have a software privacy filter overlay applied and other programs and applications do not need a software privacy filter overlay. In yet another embodiment, privacy program 112, based on the determined score in step 204, privacy program 112 determines that specific program and application should have the privacy filter overlay applied and other programs and applications should not have the privacy filter overlay applied based on comparing a threshold of each program and application, found in the information repository 114, to the score.

In an embodiment, privacy program 112 implements the software privacy filter overlay as a non-active window always on top of the display over the rest of the programs and/or application being displayed in the user interface. The opacity of the software privacy filter overlay is adjustable by the user or based on the programs and/or applications being displayed in order to allow the layout and structure of the apps/windows to be seen by the user but not the content. In an embodiment, the software privacy filter overlay may be turned on and/or off by a user via input, such as keyboard input and processing begins at step 206.

Privacy program 112 determines whether to use audio (decision step 208). Additionally, privacy program 112 may prompt a user to use an input/output device(s) 116, including but not limited to, headsets or other audio output devices, for the audio output. At decision step 208, privacy program 112 determines whether to use audio output to input/output device(s) 116 for content being viewed on the display of computing device 110. In other words, privacy program 112 uses the determined programs and/or applications have potential visual hacking to have a software privacy filter overlay applied to them in step 206 and then determines whether to provide audio output for those program and/or application to input/output device(s) 116. In an embodiment, the audio output may be done using a screen reader to determine the text in the program and/or application and then output to the input/output device(s) 116 to prompt user to respond using a keyboard (not shown) connected to the computing device 110. In an embodiment, a screen reader, often used by a visually-impaired user, is a software application that enables people to use a computer program. In an embodiment, a screen reader works closely with the computer's operating system to provide information about icons, menus, dialogue boxes, files and folders of the windows and programs found in the user interface of computing device 110. Because a user can see the programs and applications, and their layout and structures on the computer window, the user can more easily use screen reader to continue the task.

In an embodiment, privacy program 112 indicates, via the user interface of computing device 110, every program and/or application that has the software privacy filter overlay applied and privacy program 112 receives an indication from the user of computing device 110 of which program and/or application that privacy program 112 should provide audio to input/output device(s) 116. In an embodiment, privacy program 112 provides audio to input/output device(s) 116 for every program and/or application that has the software privacy filter overlay applied. In an embodiment, privacy program 112 provides audio to input/output device(s) 116 based on user preferences. For example, audio may be provided by privacy program 112 to input/output device(s) 116 for only programs and/or applications banking programs that the user indicated in their user preferences. In yet another embodiment, privacy program 112 may provide audio to input/output device(s) 116 for program and/or applications that have a previously determined score above a threshold determined from user preferences.

In an embodiment, in response to privacy program 112 determining not to use audio (decision step 208, no branch), processing proceeds to step 202. In an embodiment, in response to privacy program 112 determining to use audio (decision step 208, yes branch), processing proceeds to step 210.

Privacy program 112 determines audio output (step 210). At step 210, privacy program 112 determines the audio to output to input/output device(s) 116. In other words, privacy program 112, using the determined programs and/or applications in step 208, determines what text needs to be converted to audio in order to be output to input/output device(s) 116. As noted in step 210, privacy program 112 may use a screen reader built into the operating system of computing device 110. In an alternative embodiment, privacy program 112 may use any program, known in the art, to convert visual text on the screen of computing device 110 into audio.

Privacy program 112 provides the audio (step 212). At step 212, privacy program 112 provides the audio to input/output device(s) 116. In other words, privacy program 112 use the determined audio output from step 210 and provides the determined audio output to input/output device(s) 116 via computing device 110. For example, privacy program 112 may provide the audio to a pair of wired or wireless headphones connected to a computer of the user.

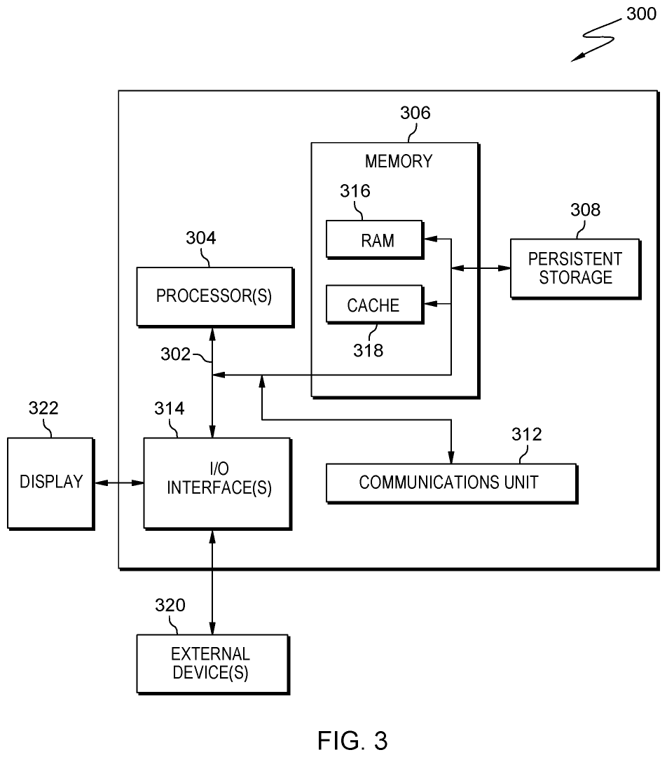

FIG. 3 is a block diagram depicting components of a computer 300 suitable for privacy program 112, in accordance with at least one embodiment of the invention. FIG. 3 displays the computer 300, one or more processor(s) 304 (including one or more computer processors), a communications fabric 302, a memory 306 including, a RAM 316, and a cache 318, a persistent storage 308, a communications unit 312, I/O interfaces 314, a display 322, and external devices 320. It should be appreciated that FIG. 3 provides only an illustration of one embodiment and does not imply any limitations with regard to the environments in which different embodiments may be implemented. Many modifications to the depicted environment may be made.

As depicted, the computer 300 operates over the communications fabric 302, which provides communications between the computer processor(s) 304, memory 306, persistent storage 308, communications unit 312, and input/output (I/O) interface(s) 314. The communications fabric 302 may be implemented with an architecture suitable for passing data or control information between the processors 304 (e.g., microprocessors, communications processors, and network processors), the memory 306, the external devices 320, and any other hardware components within a system. For example, the communications fabric 302 may be implemented with one or more buses.

The memory 306 and persistent storage 308 are computer readable storage media. In the depicted embodiment, the memory 306 comprises a random-access memory (RAM) 316 and a cache 318. In general, the memory 306 may comprise any suitable volatile or non-volatile one or more computer readable storage media.

Program instructions privacy program 112 may be stored in the persistent storage 308, or more generally, any computer readable storage media, for execution by one or more of the respective computer processors 304 via one or more memories of the memory 306. The persistent storage 308 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of the persistent storage 308.

The communications unit 312, in these examples, provides for communications with other data processing systems or devices. In these examples, the communications unit 312 may comprise one or more network interface cards. The communications unit 312 may provide communications through the use of either or both physical and wireless communications links. In the context of some embodiments of the present invention, the source of the various input data may be physically remote to the computer 300 such that the input data may be received, and the output similarly transmitted via the communications unit 312.

The I/O interface(s) 314 allow for input and output of data with other devices that may operate in conjunction with the computer 300. For example, the I/O interface 314 may provide a connection to the external devices 320, which may be as a keyboard, keypad, a touch screen, or other suitable input devices. External devices 320 may also include portable computer readable storage media, for example thumb drives, portable optical or magnetic disks, and memory cards. Software and data used to practice embodiments of the present invention may be stored on such portable computer readable storage media and may be loaded onto the persistent storage 308 via the I/O interface(s) 314. The I/O interface(s) 314 may similarly connect to a display 322. The display 322 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for providing a software based privacy filter, the computer-implemented method comprising:
receiving, by one or more computer processors, input data for a computing device of a primary user from one or more input devices, wherein the input data is selected from the group consisting of an eye gaze direction of a secondary user and a time of the eye gaze direction of the secondary user;
determining, by one or more computer processors, a score based on the input data;
comparing, by one or more computer processors, the score to a threshold;
responsive to determining the score is larger than the threshold, determining, by one or more computer processors, there is visual hacking of the computing device; and
responsive to determining there is visual hacking of the computing device, modifying, by one or more computer processors, a user interface of the computing device.

2. The computer-implemented method of claim 1, further comprising:
determining, by one or more computer processors, whether to use audio for the user interface of the computing device; and
responsive to determining to use audio for the user interface of the computing device, providing, by one or more computer processors, audio output of at least a portion of the user interface of the computing device.

3. The computer-implemented method of claim 2, wherein the step of determining, by one or more computer processors, whether to use audio for the user interface of the computing device comprises:
notifying, by one or more computer processors, a user of the computing device of potential visual hacking; and
receiving, by one or more computer processors, an indication from the user via the computing device to use audio for the user interface.

4. The computer-implemented method of claim 3, further comprising:
responsive to receiving an indication to use audio for the user interface, notifying, by one or more computer processors, the user of one or more programs being displayed on the user interface; and
receiving, by one or more computer processors, an indication from the user of one or more audio output programs selected from the one or more programs being displayed; and
providing, by one or more computer processors, audio output for the one or more indicated audio output programs.

5. The computer-implemented method of claim 2, wherein the audio output is provided using a headset.

6. (canceled)

7. The computer-implemented method of claim 1, wherein the user interface is modified with a software overlay that provides 20-70% opacity.

8. A computer program product for providing a software based privacy filter, the computer program product comprising:
one or more computer readable storage media; and
program instructions stored on the one or more computer readable storage media, the program instructions comprising:
program instructions to receive input data for a computing device of a primary user from one or more input devices, wherein the input data is selected from the group consisting of an eye gaze direction of a secondary user and a time of the eye gaze direction of the secondary user;
program instructions to determine a score based on the input data;
program instructions to compare the score to a threshold;
responsive to determining the score is larger than the threshold, program instructions to determine there is visual hacking of the computing device; and
responsive to determining there is visual hacking of the computing device, program instructions to modify a user interface of the computing device.

9. The computer program product of claim 8, further comprising program instructions stored on the one or more computer readable storage media, to:
determine whether to use audio for the user interface of the computing device; and
responsive to determining to use audio for the user interface of the computing device, provide audio output of at least a portion of the user interface of the computing device.

10. The computer program product of claim 9, wherein the step to determine whether to use audio for the user interface of the computing device comprises:
program instructions to notify a user of the computing device of potential visual hacking; and
program instructions to receive an indication from the user via the computing device to use audio for the user interface.

11. The computer program product of claim 10, further comprising program instructions stored on the one or more computer readable storage media, to:
responsive to receiving an indication to use audio for the user interface, notify the user of one or more programs being displayed on the user interface; and
receive an indication from the user of one or more audio output programs selected from the one or more programs being displayed; and
provide audio output for the one or more indicated audio output programs.

12. The compute program product of claim 9, wherein the audio output is provided using a headset.

13. (canceled)

14. The computer program product of claim 8, wherein the user interface is modified with a software overlay that provides 20-70% opacity.

15. A computer system for providing a software based privacy filter, the computer system comprising:
one or more computer processors;
one or more computer readable storage media; and
program instructions, stored on the one or more computer readable storage media for execution by at least one of the one or more computer processors, the program instructions comprising:
program instructions to receive input data for a computing device of a primary user from one or more input devices, wherein the input data is selected from the group consisting of an eye gaze direction of a secondary user and a time of the eye gaze direction of the secondary user;
program instructions to determine a score based on the input data;
program instructions to compare the score to a threshold;
responsive to determining the score is larger than the threshold, program instructions to determine there is visual hacking of the computing device; and
responsive to determining there is visual hacking of the computing device, program instructions to modify a user interface of the computing device.

16. The computer system of claim 15, further comprising program instructions stored on the one or more computer readable storage media for execution by at least one of the one or more computer processors, to:
determine whether to use audio for the user interface of the computing device; and
responsive to determining to use audio for the user interface of the computing device, provide audio output of at least a portion of the user interface of the computing device.

17. The computer system of claim 16, wherein the step to determine whether to use audio for the user interface of the computing device comprises:
program instructions to notify a user of the computing device of potential visual hacking; and
program instructions to receive an indication from the user via the computing device to use audio for the user interface.

18. The computer system of claim 17, further comprising program instructions stored on the one or more computer readable storage media for execution by at least one of the one or more computer processors, to:
responsive to receiving an indication to use audio for the user interface, notify the user of one or more programs being displayed on the user interface; and
receive an indication from the user of one or more audio output programs selected from the one or more programs being displayed; and
provide audio output for the one or more indicated audio output programs.

19. The compute system of claim 16, wherein the audio output is provided using a headset.

20. (canceled)

21. (canceled)

22. (canceled)

23. (canceled)

24. The computer-implemented method of claim 1, wherein determining, by one or more computer processors, a score based on the input data comprises:
determining, by one or more computer processors, a part of the computing device being viewed by the secondary user based on the eye gaze direction of the secondary user; and
determining, by one or more computer processors, a score based on the part of the computing device being viewed by the secondary user, wherein the score is lower if the part of the computing device being viewed by the secondary user is a side of the computing device, and wherein the score is higher if the part of the computing device being viewed by the secondary user is a center of the computing device.

25. The computer-implemented method of claim 1, wherein determining, by one or more computer processors, a score based on the input data comprises:
determining, by one or more computer processors, a time of eye gaze direction at the computing device by the secondary user based on the time of the eye gaze direction of the secondary user; and
determining, by one or more computer processors, a score based on a time of eye gaze direction at the computing device by the secondary user, wherein the score is lower if the time of the eye gaze direction at the computing device by the secondary user is lower, and wherein the score is higher if the time of the eye gaze direction at the computing device by the secondary user is higher.

26. The computer-implemented method of claim 1, wherein comparing, by one or more computer processors, the score to a threshold and responsive to determining the score is larger than the threshold, determining, by one or more computer processors, there is visual hacking of the computing device comprises:
providing, by one or more computer processors, the score to the primary user via the computing device; and
responsive to providing the score to the primary user via the computing device, receiving, by one or more computer processors, an indication from the primary user determining visual hacking of the computing device.
